(19) United States
(12) Patent Application Publication
(10) Pub. No.: US 2014/0267139 A1
(43) Pub. Date: Sep. 18, 2014

(54) Touch Sensitive Surface with False Touch Protection for an Electronic Device

(71) Applicant: MOTOROLA MOBILITY LLC, Libertyville, IL (US)

(72) Inventors: Jiri Slaby, Buffalo Grove, IL (US); Roger W. Ady, Chicago, IL (US); Thomas Y. Merrell, Beach Park, IL (US)

(73) Assignee: Motorola Mobility LLC, Libertyville, IL (US)

(21) Appl. No.: 13/833,337

(22) Filed: Mar. 15, 2013

(51) Int. Cl. G06F 3/044; G06F 3/041

(52) U.S. Cl. CPC G06F 3/044; G06F 3/0416
USPC 345/174

(57) ABSTRACT

An electronic device (300) includes a housing (301) and a touch sensitive surface (303) disposed along the housing. The touch sensitive surface has a recessed surface feature (306) and a complementary non-concave surface (308).

### BACKGROUND

1. Technical Field

This disclosure relates generally to electronic devices, and more particularly to user input elements for electronic devices.

2. Background Art

“Intelligent” portable electronic devices, such as smart phones, tablet computers, and the like, are becoming increasingly powerful computational tools. Moreover, these devices are becoming more prevalent in today's society. For example, not too long ago a mobile telephone was a simplistic device with a twelve-key keypad that only made telephone calls. Today, “smart” phones, tablet computers, personal digital assistants, and other portable electronic devices not only make telephone calls, but also manage address books, maintain calendars, play music and videos, display pictures, and surf the web.

As the capabilities of these electronic devices have progressed, so too have their user interfaces. Prior keypads having a limited number of keys have given way to sophisticated user input devices such as touch sensitive screens or touch sensitive pads. Touch sensitive systems, including touch sensitive displays, touch sensitive pads, and the like, include sensors for detecting the presence of an object such as a finger or stylus. By placing the object on the touch sensitive surface, the user can manipulate and control the electronic device without the need for a physical keypad.

One drawback to touch sensitive electronic devices is that some offer limited modes of input. It would be advantageous to have an improved touch sensitive surface that offers additional modes of operation.

### BRIEF DESCRIPTION OF THE DRAWINGS

FIG. 1 illustrates a plan view of one explanatory touch sensitive surface configured in accordance with one or more embodiments of the disclosure.

FIG. 2 illustrates a sectional view of one explanatory touch sensitive surface configured in accordance with one or more embodiments of the disclosure.

FIG. 3 illustrates one explanatory electronic device configured in accordance with one or more embodiments of the disclosure.

FIG. 4 illustrates one explanatory electronic device configured in accordance with one or more embodiments of the disclosure.

FIG. 5 illustrates sectional side elevation views of explanatory touch sensitive surfaces configured in accordance with one or more embodiments of the disclosure.

FIG. 6 illustrates explanatory capacitive touchpad configurations suitable for use with touch sensitive surfaces configured in accordance with one or more embodiments of the disclosure.

FIG. 7 illustrates an alternate touch sensitive surface configured in accordance with one or more embodiments of the disclosure.

FIG. 8 illustrates another embodiment of a touch sensitive surface 803 configured in accordance with one or more embodiments of the disclosure.

FIGS. 9-12 illustrate sectional side elevation views of explanatory touch sensitive surfaces configured in accordance with one or more embodiments of the disclosure.

FIG. 13 illustrates sectional side elevation views of additional explanatory touch sensitive surfaces configured in accordance with one or more embodiments of the disclosure.

FIG. 14 illustrates a user manipulating an explanatory touch sensitive surface of an electronic device configured in accordance with one or more embodiments of the disclosure.

FIGS. 15-16 illustrates another touch sensitive surface configured in accordance with one or more embodiments of the disclosure.

FIG. 17 illustrates an explanatory capacitive touchpad configuration suitable for use with touch sensitive surfaces configured in accordance with one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION

In accordance with one embodiment, a touch sensitive surface is implemented along an exterior housing of an electronic device. In one embodiment, the touch sensitive surface includes a recessed surface and a non-recessed surface. In one embodiment, the recessed surface includes a concave surface element, while the non-recessed surface can be substantially planar, convex, undulating, or have other complex geometries. In one embodiment, the areas of the touch sensitive surface that are non-recessed are complementary to the areas that are recessed, e.g., those portions of the touch sensitive surface extending beyond a perimeter of the recessed surface feature.

The touch sensitive surface may be implemented along an exterior housing of an electronic device. For example, in one embodiment the touch sensitive surface is positioned along a rear major face of a device housing. This configuration permits the front major face of the device to accommodate a display. The user can control the device, and data presented on the display, by interfacing with the touch sensitive surface disposed on the backside of the device. Placing the touch sensitive surface on the rear of the device both provides for simpler user operation in one embodiment and leaves the entire front side of the device available for the display so that a finger does not need to occlude the touch sensitive display to interact with the images on the display. In another embodiment, the touch sensitive surface can be disposed along the front face. In still other embodiments, the touch sensitive surface can be disposed on minor faces, such as the sides of the electronic device.

In one or more embodiments, the recessed surface feature can have an oblong perimeter and can resemble a trough. In other embodiments, the recessed surface feature can have a circular perimeter. Other perimeter shapes and boundaries will be obvious to those of ordinary skill in the art having the benefit of this disclosure.

A capacitive touchpad can span the touch sensitive surface in one embodiment. While a capacitive touchpad is one technology suitable for use with the touch sensitive surface, those of ordinary skill in the art having the benefit of this disclosure will understand that other technologies can be used as well. For example, the touch sensitive surface can detect touch, in one or more embodiments, using a resistive touch sensor, a surface acoustic wave touch sensor, a surface capacitance sensor, a projected capacitance sensor, a mutual capacitance sensor, a self-capacitance sensor, an infrared grid sensor, an infrared acrylic projection sensor, an optical imaging sensor, a dispersive signal sensor, an acoustic pulse recognition sensor, and so forth.

The capacitive touchpad can be continuous or segmented. Where segmented, the segments can have different sizes so as to provide different touch sensitive surface areas. The segments can work in tandem to form a capacitive touch pad that appears to be continuous to a user, but is in actually a plurality of segments. In one or more embodiments, signals having different amplitudes can be applied to the different segments so as to provide a “tuned” capacitive touchpad that is more sensitive along some segments or portions and is less sensitive along other portions. This tuning can be based upon a desired touch response or a particular application.

To mitigate the occurrence of “false touch” detection, a grille of non-conductive material can be disposed along the touch sensitive surface and/or above the capacitive touchpad in one or more embodiments. The non-conductive material can be compressible or non-compressible. The non-conductive material can define a minimum contact force that must be applied for the capacitive touchpad to detect touch input, thereby reducing the occurrence of accidental touches being detected as touch input. The non-conductive material can be configured as a grille in one or more embodiments. The grille can define a parallel pattern of apertures, or can create apertures of other shapes, which may be quadrilateral, ovoid, or other regular and/or irregular shapes.

The inclusion of the grille atop the touch sensitive surface causes the user to press the area covered by the grille with enough force to either compress the grille (where the grille is manufactured from a compressible material) or cause a finger or stylus to at least partially squeeze between the apertures of the grille (when the grille is manufactured from a non-compressible material). This relatively small extra force provides the necessary field manipulation signal to the capacitive touchpad, and therefore counters any false touch activation that may occur when a finger lightly brushes across a prior art touch sensitive surface. One advantage of implementations of the present disclosure is that they reduce the incidence of false touch activation without requiring any additional electrical hardware or software code. The incorporation of a mechanical grille greatly reduces false touch activation occurrences for a capacitive sensor.

Another advantage of embodiments of the disclosure is that the inclusion of a concave or otherwise recessed surface feature in the touch sensitive surface can mitigate false touch detection. When the touch sensitive surface includes a concave or recessed surface feature, a user needs to apply additional force into the concave or recessed surface feature to reach the touch sensitive surface with sufficient contact as to exceed a touch activation threshold. The activation threshold within the concave or recessed surface feature can further be tuned or adjusted so as to be different—and higher in some embodiments—than other portions of the touch sensitive surface. Advantageously, they allow touch sensitive controls to be placed on the edges of the device. Those touch sensitive surfaces are not actuated when the user holds the device normally. Instead, they are only actuated when the user applies a force similar to that applied to a conventional popple-type button and/or reaches into the concave or otherwise recessed surface feature. Accordingly, embodiments of the present disclosure can be used as volume, selection, scrolling, and other controls on the outer edges of an electronic device.

FIGS. 1 and 2 illustrate one explanatory touch sensitive surface 100 configured in accordance with one or more embodiments of the disclosure. FIG. 1 illustrates a plan view of the touch sensitive surface 100, while FIG. 2 illustrates a cross-sectional view. In this explanatory embodiment, the touch sensitive surface 100 is implemented along an exterior housing 101 of an electronic device.

In one embodiment, the touch sensitive surface 100 defines an area configured with a touch sensor 201 to detect the presence of an object, such as a user's finger or stylus, when that object is proximally located with a surface 102 of the touch sensitive surface 100. The surface 102 can include a protective shield or other covering that protects the electronics of the touch sensor 201.

In one or more embodiments, the touch sensor 201 is a capacitive touchpad that spans the touch sensitive surface 100. The capacitive touchpad can be configured to detect movement of, for example, a user's finger, occurring within a region defined by, for example, the outer perimeter 103 the touch sensitive surface. The capacitive touchpad can further be configured to detect a direction of the movement within the region.

Capacitive touchpads suitable for use with embodiments of the disclosure can be constructed in a variety of ways. For example, in one embodiment the capacitive touchpad is formed by horizontal conductors and vertical conductors that cross over each other to define a grid 104 of pixels 105. One set of conductors can be coupled to a touch driver, operable with the control circuit, which delivers a signal to each pixel of the grid. Electrical charges then travel to the pixels 105 of the grid. Electromagnetic fields are then created about the pixels 105. The fields are altered by interaction of a user's finger or other conductive object interacting with the touch sensitive surface 100. This alteration allows the control circuit to detect touch input.

In one embodiment, the electrodes defining each pixel 105 can create a coordinate plane. Said differently, each pixel 105 can correspond to a different a particular geographic coordinate defined by the touch sensitive surface 100. By detecting a change in the capacitance of one or more pixels 105, the control circuit can thus determine an X and Y coordinate, and optionally the Z coordinate where the touch sensitive surface 100 is non-planar as shown in FIG. 4, at which the touch input occurs. This locational information can be used to control data on the display. Motion can be detected as well. Other forms of capacitive touchpads suitable for use with embodiments of the disclosure will be obvious to those of ordinary skill in the art having the benefit of this disclosure.

In one embodiment, the touch sensitive surface 100 includes a recessed surface feature 106 disposed along a portion of the touch sensitive surface 100. The recessed surface is delineated by a perimeter 107. Portions of the touch sensitive surface 100 disposed within the perimeter 107 constitute the recessed surface feature 106, while portions within the perimeter 103 of the touch sensitive surface 100 and outside the perimeter 107 of the recessed surface feature 106 constitute portions of the touch sensitive surface 100 that are complementary to the recessed surface feature 106. The complementary portions 108, in one embodiment, include a non-concave surface. In one embodiment the complementary portions 108 extend beyond the perimeter 107 in at least one dimension. As noted above, in one embodiment the complementary portions can be substantially planar, convex, undulating, or have other complex geometries. In this illustrative embodiment, the complementary portions 108 are substantially planar and extend from the perimeter 107 of the recessed surface feature 106.

In the illustrative embodiment of FIGS. 1 and 2, the perimeter 107 of the recessed surface feature 106 is oblong. As will be seen below with reference to FIG. 3, in another embodiment the perimeter 107 of the recessed surface feature 106 can be circular. These perimeter shapes are explanatory only, as others will be obvious to those of ordinary skill in the art having the benefit of this disclosure. For example, the perimeter 107 of the recessed surface feature 106 can be polygonal (triangular, quadrilateral, etc.) or other regular or irregular closed-form shapes (e.g., heart-shaped, clover-shaped, etc.).

As seen most clearly in FIG. 2 taken along cross-section A-A of FIG. 1 in this illustrative embodiment, the recessed surface feature 106 has a concave surface element. Those of ordinary skill in the art having the benefit of this disclosure will understand that the recessed surface feature may take other forms. For example, in one embodiment the recessed surface feature can be planar, with a bottom floor 202 being substantially flat. In another embodiment, the recessed surface feature can even be convex while being recessed, with an apex of any convex shape being recessed from the touch sensitive surface 100. Moreover, the bottom floor 202 can even be textured and may include a plurality of convex and concave features as well.

FIG. 3 illustrates an electronic device 300 having a housing 301 with a touch sensitive surface 303 disposed along the housing 301. The explanatory electronic device 300 is shown as a smart phone for ease of illustration. However, it will be obvious to those of ordinary skill in the art having the benefit of this disclosure that other portable electronic devices may be substituted for the explanatory smart phone of FIG. 3. For example, the electronic device 300 may be configured as a palm-top computer, a tablet computer, a gaming device, wearable computer, a remote controller, a media player, laptop computer, portable computer, or other electronic device.

In one embodiment, a capacitive touchpad 331 is attached to the housing 301 along the touch sensitive surface 303 so as to span the touch sensitive surface 303. As shown in FIG. 3, the touch sensitive surface 303 includes at least one recessed surface feature 306 on a portion of the touch sensitive surface 303 and at least one non-recessed surface 308. In this illustrative embodiment, the recessed surface feature 306 has a circular perimeter 307. Further, the non-recessed surface 308 extends away from the circular perimeter such that the recessed surface feature 306 and non-recessed surface, 308, which is complementary to the recessed surface feature 306, form a unitary touch sensitive surface 303.

While the complementary portion (108) of FIG. 1 was substantially planar, in the embodiment of FIG. 3, the non-recessed surface 308 has an irregularly convex overall shape. In other embodiments, the non-recessed surface 308 could be planar as well. As will be recognized by those of ordinary skill in the art having the benefit of this disclosure, the non-recessed surface 308 can take on other geometries as well.

FIG. 4 illustrates the explanatory electronic device 300 of FIG. 3 with a block diagram schematic 400. As shown in FIG. 4, the electronic device 300 includes the touch sensitive surface 303 described above. In this illustrative embodiment, the touch sensitive surface 100 is simply a portion of the housing 301 above a touch sensor 442. Using a portion of the housing 301 to define the touch sensitive surface 303 provides a streamlined look and feel that can be desirable to a consumer. The touch sensitive surface 303 includes a recessed surface feature 306 on a portion of the touch sensitive surface 303 as previously described.

Note that the housing 301 of FIG. 4 is generally convex in that a central portion 402 of the rear face of the electronic device 300 extends outwardly from the electronic device 300, i.e., out of the page as viewed in FIG. 4, relative to the side portions 404 of the rear face. It should be noted that housing substrates of electronic devices employing embodiments of the disclosure can take a variety of shapes, and can be substantially planar, convex, concave, undulating, or combinations thereof. It should be noted that while the touch sensitive surface 303 of FIG. 4 is illustratively disposed on the rear face to illustrate one or more of its advantages, such touch sensitive surfaces configured in accordance with embodiments of the disclosure could be disposed on any external surface of the electronic device.

In FIG. 4, the explanatory electronic device 300 is shown illustratively with a schematic block diagram 400. The illustrative electronic device 300 includes a user interface 406. The user interface 406 can include multiple elements, as is the case in this illustrative embodiment. Here, the user interface 406 includes a touch sensitive display 407, one or more buttons 408, 409, 410, 411, and the touch sensitive surface 303.

The touch sensitive display 407 is operable with a display driver 412. The illustrative electronic device 300 also includes a communication circuit 413 that can be configured for wired or wireless communication with one or more other devices or networks. The networks can include a wide area network, a local area network, and/or personal area network. The communication circuit 413 can include wireless communication circuitry, one of a receiver, a transmitter, or transceiver, and one or more antennas 414.

The electronic device 300 includes a control circuit 415, which can include one or more processors. The control circuit 415 is responsible for performing the various functions of the electronic device 300. In one embodiment, the control circuit 415 is operable with the touch sensor 201 to detect touch actuation from an object. The control circuit 415 can be a microprocessor, a group of processing components, one or more Application Specific Integrated Circuits (ASICs), programmable logic, or other type of processing device. The control circuit 415 can be operable with the user interface 406 and the communication circuit 413, as well as various peripheral ports (not shown) that can be coupled to peripheral hardware devices via interface connections.

The control circuit 415 can be configured to process and execute executable software code to perform the various functions of the electronic device 300. A storage device, such as memory 416, stores the executable software code used by the control circuit 415 for device operation. The executable software code used by the control circuit 415 can be configured as one or more modules 417 that are operable with the control circuit 415. Such modules 417 can store instructions, control algorithms, and so forth. The instructions can instruct processors or control circuit 415 to perform the various steps, touch sensing, predetermined gesture detection, and corresponding methods described below.

As noted above, in one embodiment, the touch sensor 442 is configured as a capacitive touchpad configured to detect movement of a user's finger or other object within a region defined by the outer perimeter 443 of the capacitive touchpad. The capacitive touchpad can further be configured to detect a direction of the movement within the region.

In one or more embodiments, the touch sensitive surface 303 is operable with an optional haptic component 418. The haptic component 418 can be configured to provide a pseudo-tactile feedback in response to user actuation sensed as a predetermined gesture along the touch sensitive surface 100. In one embodiment, the haptic component 418 can simulate the popples or spring mechanisms of conventional keys by delivering a tactile response to housing 301 of the electronic device 300 when a user delivers a predetermined gesture to the touch sensitive surface 303.

In one embodiment of a haptic component 418, a haptic layer includes a transducer configured to provide a sensory feedback when a user delivers a predetermined gesture to the touch sensitive surface 303. In one embodiment, the transducer is a piezoelectric transducer configured to apply a mechanical “pop” to the housing 301 of the electronic device 300 that is strong enough to be detected by the user. Thus, the tactile feedback layer of a haptic component 418 provides sensory feedback to the user, thereby making the touch sensitive surface 303 respond like a conventional keypad when a predetermined gesture is detected by the control circuit 415. As an alternative or addition to including a haptic device, acoustic feedback could be provided via speakers. Visible feedback could also be provided either directly from the touch sensitive display 407, or by integrating light emitting diodes, optionally with light guides, along surfaces of the electronic device 300. In another embodiment, electrostatic vibration technology may also be used on the surface top to provide haptic feedback in response to user gestures, such as swiping.

As will be described in general below, in one or more embodiments, the control circuit 415 is configured to detect a predetermined gesture sequence when a user applies touch actuation along the touch sensitive surface 303 and interacts with the recessed surface feature 306. In one embodiment, where the touch sensor 442 includes a capacitive touch sensor having capacitive electrode pairs defining pixels (105) spanning the recessed surface feature 306, the control circuit 415 can be configured to detect the predetermined gesture sequence only when the applied touch interaction interacts with a predetermined subset of the capacitor electrode pairs or pixels. For example, in one embodiment about twenty-five pixels span the surface of the recessed surface feature 306. The control circuit 415 can be configured, for example, to detect interaction with the recessed surface feature 306 when a sufficient number of pixels have sensed the touch input. One example of a number of pixels defining this predetermined subset is about ten pixels. Requiring that at least a predetermined subset of the pixels detect the touch input helps to prevent the detection of false recessed surface feature interaction when a user inadvertently contacts a small portion of the recessed surface feature 306.

FIG. 5 illustrates a touch sensitive surface 503 configured in accordance with several embodiments of the disclosure. The touch sensitive surface 503 includes a recessed surface feature 506 and a non-recessed surface 508. The touch sensitive surface 503 of this explanatory embodiment is implemented along a front major face of a housing 501 of an electronic device 500.

The touch sensitive surface 503 includes a capacitive touchpad 531 that spans the touch sensitive surface 503. The capacitive touchpad 531 can be constructed in a variety of different ways and locations. Three explanatory options are shown in FIG. 5. Others will be obvious to those of ordinary skill in the art having the benefit of this disclosure. Each embodiment is illustrated as a side elevation view of a touch sensitive surface configured in accordance with one or more embodiments of the disclosure. Each embodiment may offer an advantage for a particular application.

Illustrating by example, the first embodiment 550 represents a compromise between operational power consumption of a capacitive touchpad 531 and assembly cost and complexity for the touch sensitive surface 503. The second embodiment 551 may require less power in the capacitive sensor than the first embodiment 550 due to the fact that the capacitive sensor is disposed closer to the user's finger at actuation. The third embodiment 552 may result in a lower cost assembly than the first embodiment 550 due to fact that the assembly is simpler to manufacture.

Beginning with the first embodiment 550, the touch sensitive surface 503 includes a housing substrate 501 underside attached to the capacitive touchpad 531. The housing 501 of this illustrative embodiment 550 is a rigid layer formed of plastic, composites, or another housing material. In one embodiment, the housing 501 is manufactured from a non-conductive material. Examples of a non-conductive material suitable for forming the housing 501 would be ABS plastic, polycarbonate, or ABS-polycarbonate, and other resins.

An adhesive layer (not shown) between a major surface of the capacitive touchpad 531 and an inner surface of the housing 501 bonds the two together. As shown, the capacitive touchpad 531 is positioned on an interior side of the housing 501, while the touch sensitive surface 503 is implemented on an exterior side of the housing 501 across from the capacitive touchpad 531. If desired, the capacitive touchpad 531 can be contoured to wrap about portions of the housing 501 that are contoured to accommodate the recessed surface feature 506.

In the second embodiment 551, the housing 501 is again manufactured as a rigid layer, although it could be flexible in other embodiments. In one embodiment, the housing 501 of this embodiment 551 is manufactured from a non-conductive material. The housing 501 has been configured with recesses to accommodate the capacitive touchpad 531 and the recess of the recessed surface feature 506. The capacitive touchpad 531 is positioned on the exterior side of the housing 501 and defines the boundaries of the touch sensitive surface 503. An adhesive layer (not shown) disposed between the housing 501 and the capacitive touchpad 531 bonds the capacitive touchpad 531 to the housing 501.

In the third embodiment 552, the touch sensitive surface 503 includes a housing substrate 501 underside attached to the capacitive touchpad 531. The housing 501 of this illustrative embodiment 550 is a rigid layer formed of plastic, composites, or another housing material. An adhesive layer (not shown) bonds a major surface of the capacitive touchpad 531 to the housing 501. Although the capacitive touchpad 531 is disposed on an interior side of the housing 501, the touch sensitive surface 503 is implemented on an exterior side of the housing 501. The capacitive touchpad 531 is substantially planar in this embodiment 552.

While the capacitive touchpad 531 can be continuous in one or more embodiments, in other embodiments it can be segmented. FIG. 6 illustrates two different embodiments 650,651 of the capacitive touchpad 531. In FIG. 6, the capacitive touchpad 531 is segmented and includes a plurality of touchpad elements. For example, in the first embodiment 650, the segments 661, 662, 663, 664 are configured as concentric circles, with complementary portions 665, 666, 667, 668 employed to construct a capacitive touchpad 531 with a substantially rectangular perimeter 607. In the second embodiment 651, segments, e.g., segments 655, 656, 657, take a variety of shapes that, when arranged, can form a capacitive touchpad 531 with a substantially rectangular perimeter 607.

As shown in FIG. 6, in one or more embodiments, each segment of the capacitive touchpad 531 can be configured with different sizes. For example, in the first embodiment 650, segment 663 is larger than segment 662. Similarly, in the second embodiment 651, segment 657 is larger than segment 655. The segments can be one size within the perimeter 607, and other sizes outside the perimeter 607.

In one or more embodiments, a control circuit, e.g., control circuit (415) of FIG. 4, can be configured to be operable with the capacitive touchpad 531. To tune sensitivity along the capacitive touchpad 531, the control circuit can deliver signals having different magnitudes to the various capacitive touchpad segments. In one embodiment the control circuit may apply first signals having a first amplitude to at least a first touchpad segment and a second signal having a second amplitude to at least a second touchpad segment. Illustrating by example, to tune the capacitive touchpad 531 to be more sensitive in the middle, a signal with a higher amplitude may be delivered to segment 661 while a signal with a lesser amplitude is delivered to segment 663, and so forth.

FIG. 7 illustrates another embodiment of a touch sensitive surface 703 configured in accordance with one or more embodiments of the disclosure. The touch sensitive surface 703 includes a recessed surface feature 706 and a non-recessed surface 708. This explanatory recessed surface feature 706 is oblong. The touch sensitive surface 703 of this explanatory embodiment is positioned along a side edge of a housing 701 of an electronic device.

The touch sensitive surface 703 includes a capacitive touchpad 731 that spans the touch sensitive surface 703. The capacitive touchpad 731 can be constructed in a variety of different ways and locations. Three explanatory options are shown in FIG. 7. Others will be obvious to those of ordinary skill in the art having the benefit of this disclosure. Each embodiment is illustrated as a side elevation view of a touch sensitive surface configured in accordance with one or more embodiments of the disclosure. As noted above, each embodiment may offer an advantage for a particular application.

Beginning with the first embodiment 750, the touch sensitive surface 703 includes a housing substrate 701 underside attached to the capacitive touchpad 731. The housing substrate 701 of this illustrative embodiment 750 is a rigid layer formed of plastic, composites, or another housing material. In one embodiment, the housing 701 is manufactured from a non-conductive material. Examples of a non-conductive material suitable for forming the housing 701 would be ABS plastic, polycarbonate, or ABS-polycarbonate, and other resins.

An adhesive layer (not shown) disposed between a major surface of the capacitive touchpad 731 and the housing 701 bonds the two together. As shown, the capacitive touchpad 731 is disposed on an interior side of the housing 701, while the touch sensitive surface 703 is implemented on an exterior side of the housing 701. If desired, the capacitive touchpad 731 can be contoured to wrap about portions of the housing 701 that are contoured to accommodate the recessed surface feature 706.

In the second embodiment 751, the housing 701 is again manufactured as a rigid layer, although it could be flexible in other embodiments. In one embodiment, the housing 701 of this embodiment 751 is manufactured from a non-conductive material. The housing 701 has been configured with recesses to accommodate the capacitive touchpad 731 and the recess of the recessed surface feature 706. The capacitive touchpad 731 is disposed on the exterior side of the housing 701 and defines the boundaries of the touch sensitive surface 703. An adhesive layer (not shown) disposed between the housing 701 and the capacitive touchpad 731 bonds the capacitive touchpad 731 to the housing 701.

In the third embodiment 752, the touch sensitive surface 703 includes a housing substrate 701 underside attached to the capacitive touchpad 731. The housing substrate 701 of this illustrative embodiment 750 is a rigid layer formed of plastic, composites, or another housing material. An adhesive layer (not shown) bonds a major surface of the capacitive touchpad 731 to the housing 701. Although the capacitive touchpad 731 is disposed on an interior side of the housing 701, the touch sensitive surface 703 is implemented on an exterior side of the housing 701 opposite the capacitive touchpad 731. The capacitive touchpad 731 is substantially planar in this embodiment 752.

FIG. 8 illustrates another embodiment of a touch sensitive surface 803 configured in accordance with one or more embodiments of the disclosure. This explanatory recessed surface feature 806 of this touch sensitive surface 803 is oblong and concave. The touch sensitive surface 803 of this explanatory embodiment is disposed along a side edge of a housing 801 of an electronic device and also includes complementary non-recessed areas. In this embodiment, the touch sensitive surface 803 of FIG. 8 includes a recessed surface feature 806 (recessed relative to non-recessed surfaces 808 of the touch sensitive surface 803) with a floor 880 that is substantially planar, as shown in the sectional views of FIGS. 9-12 taken along section line 801. The touch sensitive surface 803 also includes portions 808 disposed outside the perimeter 807 of the recessed surface feature 806.

The touch sensitive surface 803 includes a capacitive touchpad that spans the touch sensitive surface 803. The capacitive touchpad can be constructed in a variety of different ways and locations. Three explanatory options are shown in FIGS. 9-12. Others will be obvious to those of ordinary skill in the art having the benefit of this disclosure. Each embodiment is illustrated as a side elevation view of a touch sensitive surface configured in accordance with one or more embodiments of the disclosure.

FIGS. 9-12 illustrate different implementations of touch sensitive surfaces constructed in accordance with embodiments of the disclosure. Each figure shows a side elevation view of a different embodiment of a touch sensitive surface configured in accordance with one or more embodiments of the disclosure. Each embodiment may offer an advantage for a particular application. Illustrating by example, the embodiment of FIG. 9 may require less power in the capacitive sensor than the embodiment of FIG. 10 due to the fact that the capacitive sensor is disposed closer to the user's finger at actuation. The embodiment of FIGS. 11-12 can result in lower power consumption than FIG. 10 because conductive material connects to the capacitive sensor at certain locations.

Beginning with FIG. 9, the touch sensitive surface 803 is implemented using a capacitive touchpad 831. The housing 801 underside is attached to the capacitive touchpad 831. The housing 801 of this illustrative embodiment is a rigid layer formed of plastic, composites, or another housing material. In one embodiment, the housing 801 is manufactured from a non-conductive material. An adhesive layer 980 between the capacitive touchpad 831 and the housing 801 exterior surface bonds the two together.

In FIG. 10, the touch sensitive surface 803 again includes the housing 801 and a capacitive touchpad 831. The housing 801 of this illustrative embodiment is a rigid layer, although it could be flexible in other embodiments. In one embodiment, the housing 801 is manufactured from a non-conductive material. An adhesive layer 1080 attaches the housing 801 and the capacitive touchpad 831. As shown, the capacitive touchpad 831 is positioned on an interior side of the housing 801 opposite the touch sensitive surface 803 implemented on an exterior side of the housing 801.

In FIG. 11 the touch sensitive surface 803 includes the housing 801. The housing 801 of this embodiment includes both a non-conductive portion 1118 and a conductive portion 1119. The non-conductive portion 1118 of the housing 801 is disposed on either side of the recessed surface feature 806, while the conductive portion 1119 is disposed along the width and length of the floor 880 of the recessed surface feature 806. In this illustrative embodiment, the conductive portion 1119 has one or more non-conductive elements 1120 integrated into the conductive material forming the conductive portion 1119 of the floor 880. While optional, the one or more non-conductive elements 1120 integrated into the conductive material allow a control circuit operable with the capacitive touchpad 831 to detect the location of a user's finger or other object along the floor 880. An adhesive layer 1180 bonds the capacitive touchpad 831 to the conductive portion 1119 of the housing 801

In FIG. 12 the touch sensitive surface 803 includes the housing 801. In this embodiment, the housing includes non-conductive portions 1218 and conductive portions 1219. Some non-conductive portions 1218 of FIG. 12 are disposed outside the recessed surface feature 806 of the touch sensitive surface 803. In this case, touchpad sensitivity is optimized for detection through the housing. An adhesive layer 1280 bonds the capacitive touchpad 831 spanning the touch sensitive surface 803 to the housing 801 interior that is opposite the touch sensitive surface 803.

FIG. 13 illustrates various embodiments of a touch sensitive surface 1303 configured in accordance with one or more embodiments of the disclosure. The touch sensitive surface 1303 includes a recessed surface feature 1306 and complementary non-recessed surface features 1308. The touch sensitive surface 1303 further includes a secondary recessed surface feature 1336 disposed along the first recessed surface feature 1306. As shown in FIG. 13, the secondary recessed surface feature 1336 can be round, as indicated by the solid line perimeter 1307, oblong, as indicated by the dashed line perimeter 1337, or can take other shapes. The touch sensitive surface 1303 of this explanatory embodiment is positioned along a side edge of a housing 1301.

The touch sensitive surface 1303 includes a capacitive touchpad 1331 that spans the touch sensitive surface 1303. The capacitive touchpad 1331 can be constructed in a variety of different ways and positions. Three explanatory options are shown in FIG. 13. Others will be obvious to those of ordinary skill in the art having the benefit of this disclosure. Each embodiment is illustrated as a side elevation view of a touch sensitive surface configured in accordance with one or more embodiments of the disclosure. Each embodiment may offer an advantage for a particular application.

Illustrating by example, the first embodiment 1350 balances between assembly cost for the touch sensitive surface 1303 and power consumption for the capacitive touchpad 1331. The second embodiment 1351 may require less power in the capacitive sensor than the first embodiment 1350 due to the fact that the capacitive sensor is closer to the user's finger at actuation. The third embodiment 1352 may result in a lower cost assembly than the first embodiment 1350 due to fact that the assembly is simpler to manufacture.

Beginning with the first embodiment 1350, the touch sensitive surface 1303 includes a housing substrate 1301 underside attached to the capacitive touchpad 1331. The housing 1301 of this illustrative embodiment 1350 is a rigid layer formed of plastic, composites, or another housing material. In one embodiment, the housing 1301 is manufactured from a non-conductive material. Examples of a non-conductive material suitable for forming the housing 1301 would be ABS plastic, polycarbonate, or ABS-polycarbonate, and other resins.

An adhesive layer bonds a major surface of the capacitive touchpad 1331 and the housing 1301 interior surface. Although the capacitive touchpad 1331 is disposed on an interior side of the housing 1301, the touch sensitive surface 1303 is implemented on an exterior side of the housing 1301 opposite the capacitive touchpad 1331. If desired, the capacitive touchpad 1331 can be contoured to wrap about portions of the housing 1301 that are contoured to accommodate the recessed surface feature 506.

In the second embodiment 1351, the housing 1301 is again manufactured as a rigid layer, although it could be flexible in other embodiments. In one embodiment, the housing 1301 of this embodiment 1351 is manufactured from a non-conductive material. The housing 1301 has been configured with recesses to accommodate the capacitive touchpad 1331 and the recess of the recessed surface feature 1306. The capacitive touchpad 1331 is disposed on the exterior side of the housing 1301 and defines the boundaries of the touch sensitive surface 1303. An adhesive layer (not shown) disposed between the housing 1301 and the capacitive touchpad 1331 bonds the capacitive touchpad 1331 to the housing 1301.

In the third embodiment 1352, the touch sensitive surface 1303 includes a housing substrate 1301 underside attached to the capacitive touchpad 1331. The housing 1301 of this illustrative embodiment 1352 is a rigid layer formed of plastic, composites, or another housing material. An adhesive layer bonds a major surface of the capacitive touchpad 1331 to the housing 1301 interior surface. Although the capacitive touchpad 1331 is disposed on an interior side of the housing 1301, the touch sensitive surface 1303 is implemented on an exterior side of the housing 1301 opposite the capacitive touchpad 1331. The capacitive touchpad 1331 is substantially planar in this embodiment 1352.

In one or more embodiments, a user can control the device, and data presented on the display, by interfacing with the various touch sensitive surfaces described above. A control circuit, which is operable with the touch sensitive surface, is configured to detect a predetermined gesture sequence along the touch sensitive display. In one or more embodiments, a control circuit can be configured to detect a predetermined gesture sequence that occurs when a user's finger, stylus, or other object interacts with a concave surface element.

For example, in one embodiment, a user's finger can begin within the perimeter of the recessed surface feature, and then traverse the perimeter of the recessed surface feature to terminate along portions of the touch sensitive surface that are complementary to the recessed surface feature. In another embodiment, the opposite can occur, i.e., a user's finger can begin outside the perimeter of the recessed surface feature, and then traverse the perimeter of the recessed surface feature to terminate within the perimeter of the recessed surface feature. In yet another embodiment, a predetermined gesture can begin and terminate along portions of the touch sensitive surface that are complementary to the recessed surface feature, but pass through the recessed surface feature while the gesture is occurring. In one or more embodiments, when a predetermined gesture is detected, the control circuit can execute an operation corresponding to the predetermined gesture to control the electronic device and/or data presented on the display. For example, the control circuit can increase or decrease a volume output of the electronic device, pan through data presented on a display of the electronic device, perform a zoom operation on the data presented on the display of the electronic device, deliver a haptic response, or combinations thereof.

In one embodiment, to assist in preventing false detection of predetermined gestures, a user must interact with a minimum threshold of pixels spanning the recessed surface feature. Illustrating by example, if twenty-five pixels are disposed along the recessed surface feature, touch input may have to be received by, say, at least ten pixels for the control circuit to register an interaction with the recessed surface feature. Setting such a threshold helps to prevent accidental brushing or light touches occurring on only portions of the recessed surface feature from being detected as at least as portion of some predetermined gestures.

FIG. 14 illustrates a user 1400 initiating a predetermined gesture sequence by placing a finger 1401 into the recessed surface feature 306. The user 1400 can then move 1402 the finger 1401 out of the recessed surface feature 306 to traverse the perimeter 307 of the recessed surface feature 306 to finish along the touch sensitive surface 303 at a location outside the perimeter 307 of the recessed surface feature 306. In one embodiment, the control circuit (415) is configured to recognize this “beginning inside the recessed surface feature and finishing outside the recessed surface feature” as a predetermined gesture sequence. Other predetermined gestures may “begin outside the recessed surface feature and finish inside the recessed surface feature” or “begin outside the recessed surface feature, traverse the recessed surface feature, and finish outside the recessed surface feature”.

Upon detecting the predetermined gesture sequence, the control circuit (415) can perform an operation. One example of such an operation is increasing or decreasing a volume output of a speaker 1403 of the electronic device 300. Other operations include panning through data presented on a display of the electronic device 300, performing a zoom operation on the data presented on the display of the electronic device 300, delivering a haptic response with the haptic component (418) of the electronic device, or combinations thereof. Other operations will be obvious to those of ordinary skill in the art having the benefit of this disclosure.

FIG. 15 illustrates one embodiment of a touch sensitive surface 1503 configured in accordance with one or more embodiments of the disclosure. The touch sensitive surface 1503, can be implemented using a capacitive touchpad and include at least one recessed surface feature 1506 and at least one complementary non-recessed surface feature 1508 as previously described. The touch sensitive surface 1503 may include a first grille 1513 of non-conductive material disposed along the touch sensitive surface 1503 and a second grille 1520 of non-conductive material disposed along the touch sensitive surface 1503. The first grille 1513 and the second grille 1520 may be disposed along an external surface of the recessed surface feature 1506. The first grille 1513 and the second grille 1520 are separated distally by a length 1521 along the touch sensitive surface 1503. Note that any capacitive touchpad disposed along the length 1521 of the touch sensitive surface 1503 can be segmented such that the segments are actuated sequentially when a user swipes a finger across the segments. Accordingly, a control circuit operable with the capacitive touchpad can detect gesture input. In this embodiment, the touch sensitive surface 1803 extends beyond a boundary 1522 of the first grille 1513 in at least one dimension 1523. Similarly, the touch sensitive surface 1503 extends beyond a boundary 1524 of the second grille 1520 in at least one dimension 1525.

In one embodiment, the first grille 1513 and second grille 1520 are manufactured from a non-conductive material, i.e., a material that does not conduct electromagnetic signals. Examples of non-conductive materials include plastic, polymers, and rubber, although others will be obvious to those of ordinary skill in the art having the benefit of this disclosure. In one embodiment, the first grille 1513 and the second grille 1520 are manufactured from a compressible material. In another embodiment, the first grille 1513 and the second grille 1520 are manufactured from a non-compressible material.

In the illustrative embodiment of FIG. 15, the first grille 1513 and the second grille 1520 create a parallel pattern of non-conductive members, each spanning the width of the recessed surface feature 1506. It will be clear to those of ordinary skill in the art having the benefit of this disclosure that other configurations of non-conductive elements could be used as well. Some may not need a grille at all. For example, in one embodiment the non-conductive members are configured as a simple compressible layer. In such an embodiment, when the layer is compressed a touch interaction will be detected. However, when uncompressed, the touch interaction will not be detected. Moreover, grille geometries other than that shown in FIG. 15, including those that have non-linear apertures, can be employed as well. The first grille 1513 and the second grille 1520 can create a grating of parallel apertures through which the touch sensitive surface 1503 is exposed.

The first grille 1513 and the second grille 1520 selectively cover the recessed surface feature 1506 with a non-conductive material, which means that the touch sensitive surface 1503 detects a user's finger or other conductive object within the recessed surface feature 1506 during application of a threshold amount of normal force. In one embodiment, the size of the first grille 1513 and the second grille 1520 are configured to correspond to an average fingerprint surface area so as to further prevent false actuation from objects that are smaller than an ordinary finger. Because a non-zero threshold normal force component actuates the touch sensitive surface 1503 through the first grille 1513 or the second grille 1520, the grille material reduces “falsing” or false activations of the touch sensitive surface 1503 within the recessed surface feature 1506. The use of the touch sensitive surface 1603 advantageously can function as a conventional key or button to make an electronic device more dust resistant, water resistant, or more reliable. The touch sensitive surface 1503 of FIG. 15 can further be turned ON or OFF electronically. Moreover, the field strength of the touch sensitive surface 1503 can be tuned or optimized to support a different touch experience for the user. For example, the capacitive touchpad sensitivity can be increased to actuate with a lighter normal-direction touch, and correspondingly can be decreased when more normal-direction force is desired to actuate a particular sensor.

In the configuration of FIG. 15, each grille 1513, 1520 defines a region 1526, 1527 of the touch sensitive surface where a user must apply a sufficient force component for a control circuit to detect a touch activation. Accordingly, each region 1526, 1527 can operably function as a simulated key. By contrast, the region 1528 disposed between the first grille 1513 and the second grille 1520 can be used as a conventional touch pad. Accordingly, the control circuit can detect gesture input in this region 1528 and touch input in the regions 1526, 1527 defined by the grilles 1513, 1520. The embodiment of FIG. 15 is therefore useful as, for example, a control for a media player in that a user can perform scrolling operations 1630 in region 1628 and selection operations 1629 in regions 1626, 1627 as shown in FIG. 16. In other applications, touch input in the regions 1626, 1627 may correspond to a trigger, such as an unlocking input for the device, so as to minimize false touch activation for input gestures that may be more system-critical, leaving less system-critical inputs to be applied in region 1628.

FIG. 17 illustrates yet another embodiment of a capacitive touchpad 1731 suitable for use with embodiments of the disclosure. In FIG. 17, as with FIG. 6 above, shows a segmented capacitive touchpad 1731 and includes a plurality of touchpad elements. Each segment is configured substantially as a rectangle, although other shapes can be used as well. In one or more embodiments, each segment of the capacitive touchpad 1731 can be configured with different sizes. For example, segment 1763 is larger than segment 1762. The segmentation of FIG. 17 may be applied to any of FIGS. 7, 8, 13, and 15 with adjustments for the different touch sensitive surface implementations and recessed surface feature configurations.

In one or more embodiments, a control circuit can be configured to be operable with the capacitive touchpad 1731. To tune sensitivity along the capacitive touchpad 1731, the control circuit can deliver signals having different magnitudes to the various capacitive touchpad segments. In one embodiment the control circuit may apply first signals having a first amplitude to at least a first touchpad segment and a second signal having a second amplitude to at least a second touchpad segment. Illustrating by example, to tune the capacitive touchpad 1731 to be more sensitive in the middle, a signal with a higher amplitude may be delivered to segment 1763 while a signal with a lesser amplitude is delivered to segment 1762, and so forth.

It should be observed that the embodiments reside primarily in combinations of method steps and apparatus components related to providing a touch sensitive surface for an electronic device. Any process descriptions or blocks in flow charts should be understood as representing modules, segments, or portions of code that include one or more executable instructions for implementing specific logical functions or steps in the process. Alternate implementations are included, and it will be clear that functions may be executed out of order from that shown or discussed, including concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

It will be appreciated that embodiments of the disclosure described herein may be comprised of one or more conventional processors and unique stored program instructions that control the one or more processors to implement, in conjunction with certain non-processor circuits, some, most, or all of the functions of detecting touch activation with a capacitive touchpad or other touch sensor as described herein. The non-processor circuits may include, but are not limited to, a radio receiver, a radio transmitter, signal drivers, clock circuits, power source circuits, and user input devices. As such, these functions may be interpreted as steps of a method to perform touch sensing or touch activation operations. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure have been described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. An electronic device, comprising:
a housing;
a touch sensitive surface disposed along the housing, the touch sensitive surface including a recessed surface feature and a non-recessed surface.

2. The electronic device of claim 1, the recessed surface feature having an oblong perimeter.

3. The electronic device of claim 1, the recessed surface feature having a circular perimeter.

4. The electronic device of claim 1, further comprising:
a capacitive touchpad spanning the touch sensitive surface.

5. The electronic device of claim 4, the capacitive touchpad comprising:
a plurality of touchpad segments;
at least a first touchpad segment being larger than at least a second touchpad segment.

6. The electronic device of claim 4, further comprising:
a control circuit, operable with the capacitive touchpad, to apply a first signal having a first amplitude to at least a first touchpad segment and a second signal having a second amplitude to at least a second touchpad segment.

7. The electronic device of claim 4, further comprising:
a grille of non-conductive material disposed above at least a portion of the capacitive touchpad.

8. The electronic device of claim 7, the grille of non-conductive material comprising:
a compressible material.

9. The electronic device of claim 7, further comprising:
a control circuit, operable with the capacitive touchpad, to detect touch actuation from an object overcoming a force threshold created by the grille.

10. The electronic device of claim 7, the capacitive touchpad extending beyond a boundary of the grille in at least one surface dimension.

11. The electronic device of claim 10, further comprising:
a second grille of non-conductive material disposed above at least another portion of the capacitive touchpad.

12. The touch sensitive surface of claim 4, the capacitive touchpad disposed on an internal side of the housing, the touch sensitive surface disposed on an external side of the housing.

13. The touch sensitive surface of claim 4, further comprising:
an adhesive layer attaching the capacitive touchpad and the housing.

14. The touch sensitive surface of claim 1, the non-recessed surface being one of:
planar or convex.

15. The electronic device of claim 4, further comprising:
a control circuit, operable with the capacitive touchpad, to detect touch actuation along the touch sensitive surface.

16. The electronic device of claim 15, further comprising:
a haptic component, operable with the control circuit, the control circuit to actuate the haptic component upon detecting the touch actuation.

17. The electronic device of claim 1, the touch sensitive surface having a secondary recessed surface feature disposed along the recessed surface feature.

18. The electronic device of claim 17, further comprising:
a control circuit, operable with a capacitive touchpad, to detect touch actuation along the touch sensitive surface;
the control circuit to detect a predetermined gesture sequence when the touch actuation interacts with the secondary recessed surface feature.

19. An electronic device, comprising:
a housing substrate;
a capacitive touchpad attached to the housing substrate along a touch sensitive surface that includes at least one concave surface element and at least one non-concave surface element.

20. The electronic device of claim 19, the at least one non-concave surface element being one of:
planar or convex.
